(19) United States
(12) Patent Application Publication
(10) Pub. No.: US 2008/0235361 A1
(43) Pub. Date: Sep. 25, 2008

(54) MANAGEMENT LAYER METHOD AND APPARATUS FOR DYNAMIC ASSIGNMENT OF USERS TO COMPUTER RESOURCES

(76) Inventors: David Crosbie, Somerville, MA (US); Geoffrey Crawshaw, Needham, MA (US)

Correspondence Address: EATON PEABODY PATENT GROUP, LLC, P.O. BOX 5249, 77 Sewall Street, Suite 3000, AUGUSTA, ME, 04332-5249, US

(21) Appl. No.: 11/689,113

(22) Filed: Mar. 21, 2007

(51) Int. Cl. G06F 15/173

(52) U.S. Cl. 709/223

(57) ABSTRACT

A management layer method and apparatus for dynamically assigning computer users to remote computer resources according to predetermined rules and irrespective of remote viewer protocol utilized by the user. The method and apparatus is capable of managing hundreds of thousands of users across multiple physical sites and is operable with a wide variety of network, Internet, and application solutions. The method and apparatus is useful for an increasing mobile contemporary workforce in a world where the need for around the clock coverage coexists with the ever present possibility of catastrophic network failure.

### FIELD OF THE INVENTION

The present invention relates generally to network management of computer users and corresponding remote resources. More particularly, the present invention relates to a method and apparatus that provides a management layer dynamically assigning computer users to remote computer resources according to predetermined rules and irrespective of remote viewer protocol utilized by the user.

### BACKGROUND OF THE INVENTION

A typical standalone computer user has a computer system that includes one or more computer applications resident on their specific computer hardware. This is commonly referred to as “fat” or “thick” client architecture which includes local storage and processing such that much software resides with the user's computer. However, the advent of contemporary computer networking has allowed computer users to avail themselves to what is commonly known as “thin” or “lean” client architecture which depends primarily on a central server which includes remote storage and processing. Further, contemporary computer networking has given rise to remote desktop sharing mechanisms which often exhibit characteristics of thin client architecture.

Once such remote desktop sharing mechanism has been the development of virtual network computing (VNC) which functions through a graphical user interface (GUI). Essentially, VNC is a GUI desktop sharing system that uses remote frame buffer (RFB) protocol to remotely control another computer by transmitting keyboard and mouse events from one computer to another and relaying the graphical screen updates back in the other direction over a network. Because VNC is platform-independent and multiple clients may connect to a VNC server at the same time, this technology is popularly used for remote technical support and accessing files on one's work computer from one's home computer. However, VNC is not a secure protocol. Accordingly, variants of VNC have evolved that may be tunneled over a secure shell (SSH) or virtual private network (VPN) connection so as to add an extra security layer with stronger encryption. In parallel with such variants, proprietary systems for remote desktop sharing were developed such as Microsoft's Terminal Services™ from Microsoft Corporation of Redmond, Wash., and Citrix MetaFrame™ from Citrix Software, Inc. of Fort Lauderdale, Fla. Citrix Presentation Server™ (formerly Citrix MetaFrame™) is a remote access/application publishing product that allows users to connect to applications available from central servers.

A significant advantage of such proprietary systems is that they allow computer users to safely connect to software applications remotely via any signaling mechanism (i.e., electrical/optical/wireless) from a variety of remote locations such as their homes, airport Internet kiosks, smart phones, and other devices outside of their networks (e.g., corporate intranet). From the perspective of a corporate end-user, one can simply sign in once (Single Sign On) in to their network from a remote location such as airport kiosk and view all of the applications they would normally see every day at work (e.g. Microsoft Outlook™ or any other internal software applications), and be able to access them from the kiosk in a secure environment.

Remote desktop protocol (RDP) is part of Microsoft's Terminal Services™ and is based on licensed Citrix technology. Citrix Presentation Server™ is built on the independent computing architecture (ICA) protocol which is Citrix Systems' thin client protocol. Unlike traditional frame buffered protocols like VNC described above, ICA transmits high-level window display information as opposed to purely graphical information. Networks that use such remote viewer protocols (VNC, RDP, ICA, . . . etc.) are reminiscent of the mainframe-terminal system, where a central powerful computer does most of the processing work and smaller, much less powerful machines provide the user interface.

Corporate enterprises and academic institutions are typical users of such remote viewer protocols within their networks. From an information technology (IT) perspective, centralizing software applications through remote viewer protocols also makes it easier for IT administrators to manage both user access and their software itself. While there exists clear benefits to such centralization, there has not been widespread adoption of such systems because of a variety of reasons including user resistance, application incompatibility, and application separation.

One primary reason for such user resistance is that the user no longer has control over their desktop look and feel when logging onto such prior art remote desktop sessions. Simple features like the ability to change the desktop “wallpaper” to a personal picture turn out to be major issues to users. Such users therefore perceive no personal benefit gained from the architecture change. The application incompatibility issue arises when trying to run more than one copy of an application on a server. This is particularly problematic if the copies are not the same version. Application separation issues occur when there are multiple interdependent applications that need to be installed and run on the same host server and in the same user space. One such example of this application separation issue is regulation compliance monitoring software.

Still further, current proprietary architectures for remote desktop viewing only support their own remote viewer protocol.

Yet still further, the standard approach in regard to current architectures utilizes a proxy within the data path between a remote user and the central server. Such proxy usage limits network robustness in failure situations, increases tromboning (where remote viewer traffic has to travel through a convoluted network path as it goes from the user's device to the proxy and then to the server), and inhibits scalability. Such scalability concerns are particularly acute for multi-screen and rich media (video and audio) applications. It is, therefore, desirable to provide an improvement to network management of computer users and corresponding remote resources that overcomes these issues.

### SUMMARY OF THE INVENTION

It is an object of the present invention to obviate or mitigate at least one disadvantage of previous mechanisms for network management of computer users and corresponding remote resources. The present invention is useful for an increasing mobile contemporary workforce in a world where the need for 24/7 coverage coexists with the ever present possibility of catastrophic network failure. In general, the present invention provides a method and apparatus in the form of a management layer that dynamically assigns computer users to a respective remote computer resource in accordance with predetermined rules and yet irrespective of any given remote viewer protocol utilized by the user. Moreover, operation of the present invention is advantageously accomplished without requiring the remote viewer protocol to be routed via the apparatus.

In a first aspect, the present invention provides a method of managing remote computer resources including: collecting elements of varied type within a network; importing members corresponding to each the varied type into a processing unit for brokering connections within the network; sorting the members into member pools in accordance with predetermined rules; and forming in real-time, by way of the processing unit, a remote networking session for a remote user corresponding to one of the members in accordance with a configuration unique to the remote user.

In a further embodiment, there is provided an apparatus for managing remote computer resources including: a processing unit for brokering connections within a network, the processing unit capable of: collecting elements of varied type within the network, importing members corresponding to each the varied type into the processing unit, sorting the members into member pools in accordance with predetermined rules, and forming, in real-time, a remote networking session for a remote user corresponding to one of the members in accordance with a configuration unique to the remote user; and a storage unit capable of retaining the predetermined rules and the configuration, the storage unit operatively coupled to the processing unit.

In further aspect, the present invention provides a method of managing remote computer resources including: collecting elements of varied type within a first geographical area of a geographically diverse network; importing members corresponding to each the varied type into a processing unit for brokering connections within the first geographical area; sorting the members into member pools in accordance with predetermined rules; repeating the steps of collecting, importing, and sorting for a second geographical area of the geographically diverse network; redirecting, by way of a redirector unit, a remote user to one the processing unit corresponding to one of the first or second geographical area of the geographically diverse network corresponding to a home location of the remote user; and forming in real-time, by way of the processing unit to which the redirector unit has redirected the remote user, a remote networking session for the remote user corresponding to one of the members in accordance with a configuration unique to the remote user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 shows an overall network architecture in accordance with the present invention.

FIG. 1A shows a back-end session of a network connection in accordance with the present invention.

FIG. 2A shows a graphical user interface upon initiating a network connection in accordance with the present invention.

FIG. 2B illustrates authentication upon initiating a network connection in accordance with the present invention.

FIG. 2B illustrates authentication upon initiating a network connection in accordance with the present invention.

FIG. 3 illustrates a graphical user interface subsequent to initiating a network connection for setting up multiple sessions in accordance with the present invention.

FIG. 4 illustrates management of a remote desktop setup in terms of an RDP session.

FIG. 5 illustrates pooling in accordance with the present invention.

FIG. 5A shows the overall operational scheme of the present invention as categorized into four distinct stages.

FIG. 5B shows the management layer characteristics in relation to the four distinct stages of the present invention.

FIG. 6 illustrates desktop creation via the use of templates within the present invention.

FIG. 7 illustrates one example of the present invention in operation with SSL-VPN hardware.

FIG. 8 illustrates failover and clustering scenarios in accordance with the present invention.

FIG. 8A illustrates a virtual machine in communication with a connection broker according the present invention.

FIG. 8B illustrates the primary and backup datacenter details of FIGS. 8 and 8A in terms of the failover process.

FIG. 9 illustrates an example of location based connection brokering in accordance with the present invention.

### DETAILED DESCRIPTION

Generally, the present invention provides a method and apparatus for managing a network by dynamically assigning computer users to remote computer resources according to predetermined rules and irrespective of remote viewer protocol utilized by the user. The predetermined rules can be modified (typically by a network administrator) given the institutional needs of overall network. The present invention is implemented in the form of a connection broker that provides users with controlled remote access to hosted desktops that are running in virtual and physical machine environments. Hosted desktops centralize sensitive information and therefore reduce risk of data loss. The connection broker also provides policy-based connectivity between fat, thin, and web-based clients to physical machines, virtual machines, or server-hosted sessions (such as Citrix or the like) using the most appropriate remote desktop protocol. Indeed, the present invention provides a protocol-agnostic solution to the problem of connecting users to the computing resources they need to do their jobs. The present invention is preferably web-services-based in that the invention is deployed within a network by the use of web services and a web browser based interface enables the use of the standard network load balancing tools that are commonly used for web servers. This allows the present invention to utilize well understood web technology and knowledge such as, but not limited to network load balancing tools and provisioning the present invention to be supplied to a user as a virtual appliance.

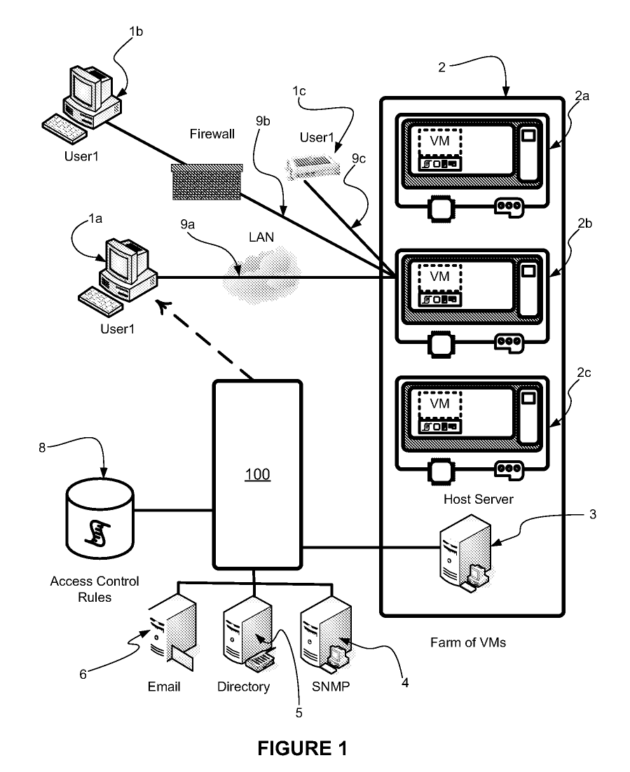

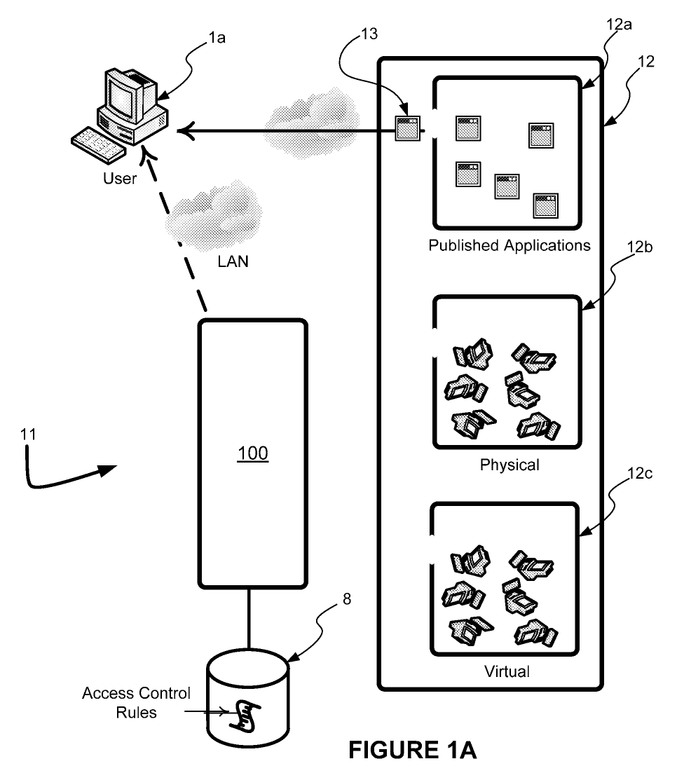

With regard to FIG. 1, an overall network architecture 100 in accordance with the present invention is shown. The end-user may be either a fat-client 1a, a thin-client 1c, or a web-client 1b (shown firewalled). A networking management mechanism in the form of a connection broker (CB) 100 is operatively coupled between the client (thin, fat, or web) and a virtual machine (VM) farm 2 having one or more VM among one or more host servers (three are shown as 2a-2c). For purposes of illustration, three clients 1a-1c are shown having respective data paths 9a-9c through a network 9 to a virtual machine resident on host server 2b. However, it should be understood that only one client would in fact be coupled per data path to any given virtual machine.

The network 9 typically carries data using electrical signaling, optical signaling, wireless signaling, a combination thereof, or any other signaling method known to the networking art. Accordingly, it should be readily apparent that the network 9 can be a fixed channel telecommunications link such as a T1, T3, or 56 kb line; local area network (LAN) or wide area network (WAN) links; a packet-switched network such as TYMNET; a packet-switched network of networks such as the Internet; or any other network configuration known to the art. The network 9 typically carries data in a variety of protocols, including but not limited to: user datagram protocol (UDP), asynchronous transfer mode (ATM), X.25, and transmission control protocol (TCP).

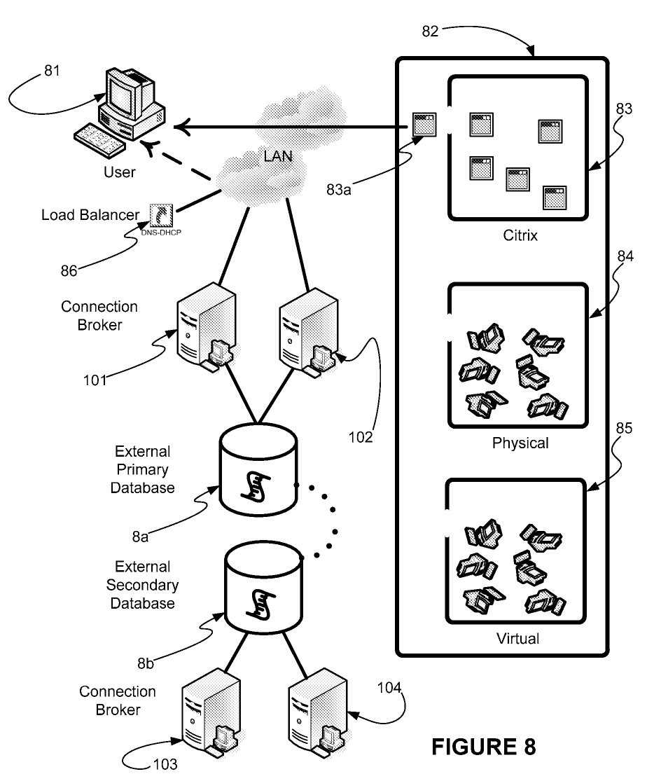

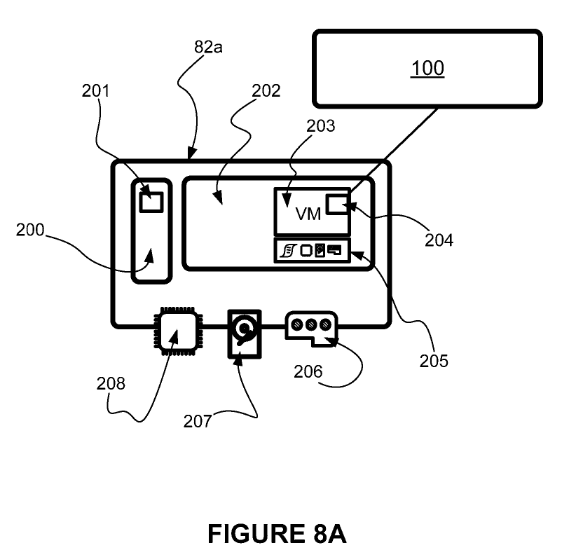

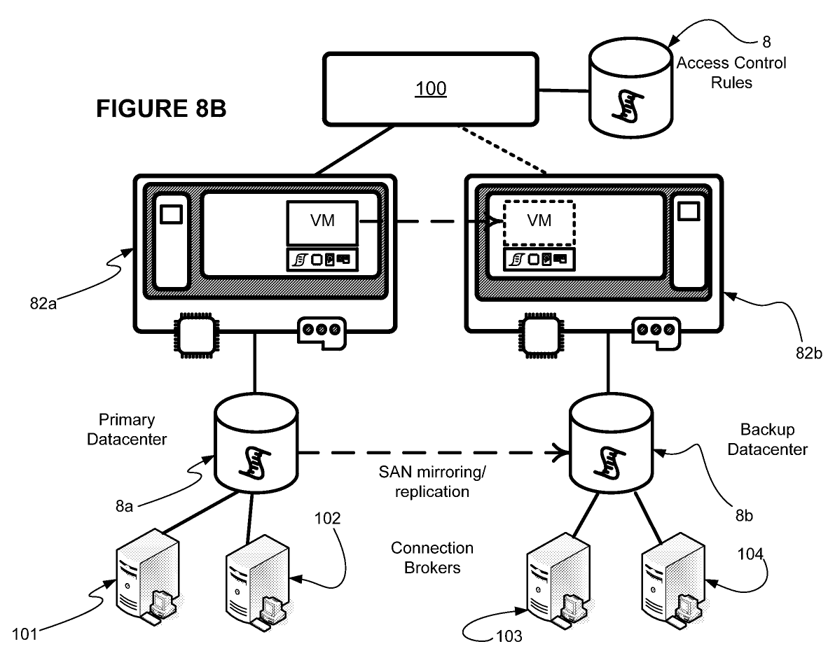

Each VM is formed within a host server 2a-2c shown in FIG. 1 whereby each VM functions as a hosted desktop. Because each hosted desktops looks and behaves like physical desktops, there is generally no user retraining required. In such instance, a virtualization management system 3 is provided to monitor and store the vital statistics of each hosted desktop within the VM farm 2. As is known within the virtualization art, each VM typically includes a virtual machine and virtual hardware along with virtualization software having a host agent in direct communication with the Connection Broker or indirect communication via a virtualization management system. 3. It should be understood that there are several known virtualization management products and indeed different virtualization layers useful within the present invention. Further, it should be understood that it is possible to manage the virtualization of hosted desktops directly and not via the management layer. As such an alternative, the present invention may manage the virtualization nodes directly. Although one or more VM are shown and described herein, it should be readily apparent that actual physical machines may exist in lieu of a farm of VMs without straying from the intended scope of the present invention. Indeed, each such physical machine (not shown) may of course be a desktop personal computer (PC), or a blade PC, running the back-end session of the network connection. In the case of physical machines the hosted desktops running within such physical machines would be found using a discovery protocol such as service location protocol (SLP), an authentication system, or by running a hosted desktop agent (e.g., a hosted desktop communications API within the hosted desktop as shown hereinbelow with regard to FIG. 8A). Further, the back-end session may alternatively be published Citrix sessions rather than one or more VM or physical machine as further shown and described hereinbelow in regard to FIG. 1A.

In FIG. 1A, a back-end session 11 of the network connection in accordance with the present invention is shown. Here, it is illustrated that the CB 100 can support a remote host 12 that may include published applications 12a (e.g. Citrix sessions or other similar terminal server sessions), physical machines 12b, and virtual machines 12 so as to provide the user 1a with remote access pursuant to access control rules 8. It should be understood that discovery and control in the back-end session occurs with respect to the Citrix sessions 12a using the Citrix Presentation Server™ application programming interface (API), with respect to physical machines 12b typically using Active Directory™ (Microsoft's directory service that forms an integral part of the Windows 2000™ architecture), and with respect to virtual machines 12 using a virtualization management layer, such as VirtualCenter™ (a virtual infrastructure management software from VMware, Inc. of Palo Alto, Calif. that centrally manages an enterprise's virtual machines as a single, logical pool of resources).

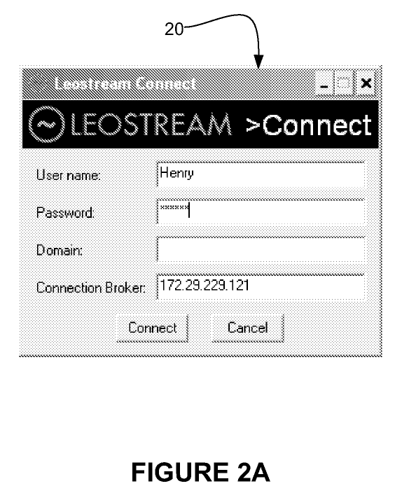

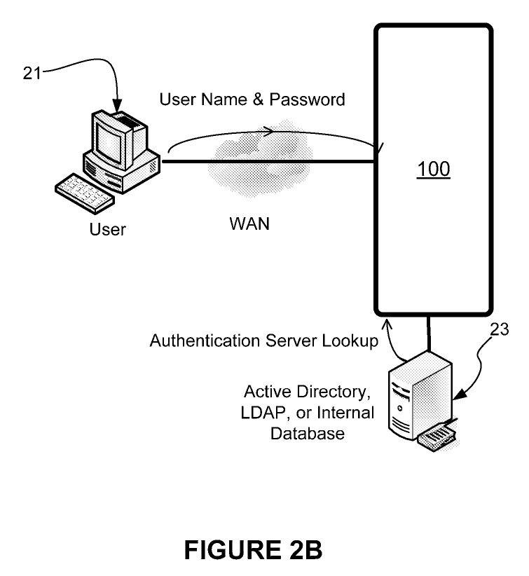

A remote user within the networking architecture 100 shown in FIG. 1 will first encounter the CB 100 via a connect application GUI 20 as shown in FIG. 2A. The domain and internet protocol (IP) of the CB 7 may be entered by the remote user (21 in FIG. 2B) or established during software initialization and setup of the CB 100 by the user's IT administrator. However, the remote user 21 will of course be required to enter a user name and password in the standard manner of logging on to a network known in the art. With further regard to FIG. 2B, the user name and password are forwarded to the CB 22 which is operatively coupled to a lookup directory 23 (e.g., an Active Directory™, LDAP, internal database, or the like) to therefore perform an authentication server lookup so as to authenticate the remote user 21. In the instance of a fat-client, a user will log on using the connection GUI 20 in accordance with the present invention that is operable in conjunction with their operating system (OS) such as, but not limited to, Microsoft Windows XP™ or Microsoft Windows Vista™.

In the instance of a thin-client, a user may utilize their thin client software to log on. Here, such thin-client would communicate with the CB 100 via an API that allows the user first to be authenticated and a Hosted Desktop assigned, then the CB to feedback to the end user device a progress report on the assignment—so they are aware of situations such as no available desktops, or that they need to wait while the hosted desktop is being provisioned. Integration with an existing remote desktop viewer ensures a highly responsive user experience and avoids the need for further software layers such as Java™ of Sun Microsystems, Inc., Santa Clara, Calif. In either fat-client or thin-client instance, the user is immediately logged into an RDP session after authentication. In the instance of a web-client however, the user would log in via a secure webpage which may necessitate further software layers such as an ActiveX™ plug-in (a high-level, Internet/Intranet technologies from Microsoft Corp. or Redmond, Wash.). It should be noted that a single log-on from either thin or fat clients avoids the need to re-enter usernames and passwords.

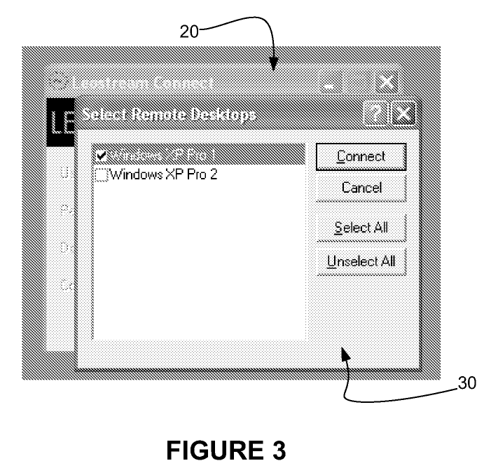

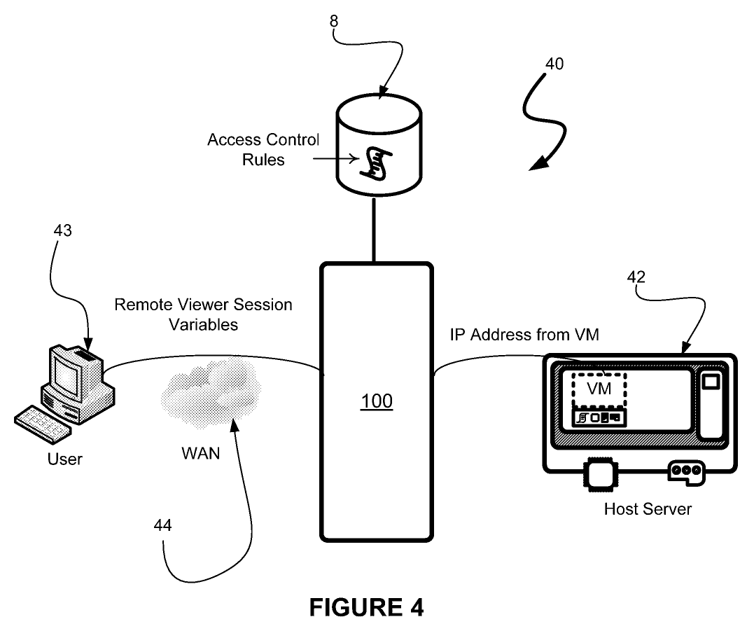

The connection GUI 20 may further include an option for the user to choose from one or more remote desktops in a remote desktop selection GUI 30. As shown in FIG. 3, the user authenticates with the connection GUI 20 after which authentication the user is then given a choice of remote desktop sessions. In such instance, the remote user can be assigned more than one remote session. Connecting from the remote desktop GUI 30 will then automatically launch and log in the user to multiple sessions. In this manner, the inventive method and apparatus effectively enables multi-session management. Such management will now be described in regard to FIG. 4 in terms of an RDP session. Although FIG. 4 is discussed in terms of an RDP session, it should be understood that the session may be that of any remote viewer protocol.

FIG. 4 shows a schematic illustrating remote viewer session control 40. After authentication as discussed above, the CB 100 then sets up the remote desktop session by sending the remote viewer session variables (here via WAN 44), including the IP address of the hosted desktop 42 (here illustrated by a VM on a host server) to the remote viewer software running on the user's local device 43. The present invention provides support for a wide range of remote desktop session protocols so as to enable the complexity of the backend system to be hidden from the user—i.e., the user simply logs in and is automatically connected to the appropriate resource using the necessary connectivity. Though not discussed previously, it should be readily apparent that the local device 43 may be a remote PC (as shown) or alternatively any remote computing device such as, but not limited to, a personal digital assistant (PDA), Internet-capable smartphone, portable e-mail device, or any digital device capable of processing a remotely hosted application. In accordance with the present invention, the session variables are derived from access control rules stored for retrieval by the CB 100. The access control rules are typically established by the user's IT administrator and may be maintained in a dynamic manner with the ability to write logic rules in a script language to determine which particular variables to use in that particular scenario. The access control rules may be unique to a specific user, client device, or network resource. Alternatively, the access control rules may be subject to a specific user or network resource grouping, sub-grouping, or some other hierarchy or criteria-based configuration discussed further hereinbelow as pooling.

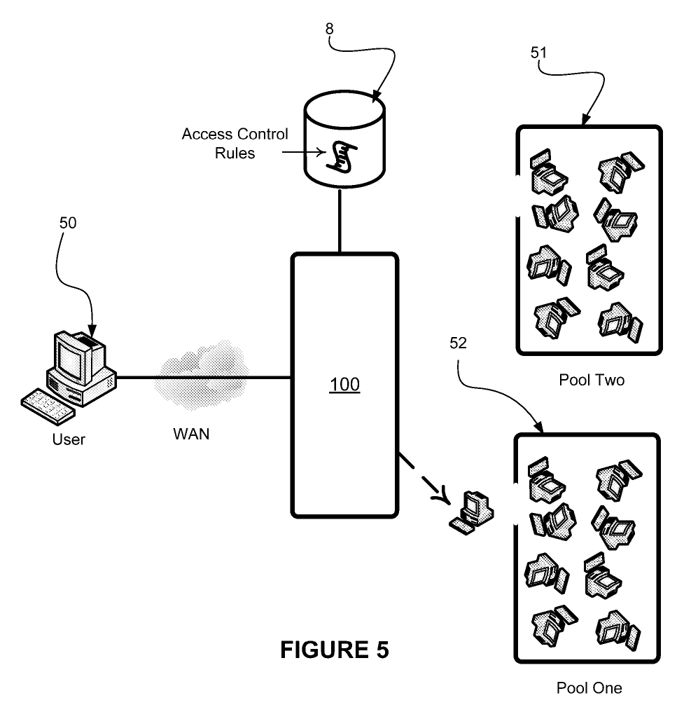

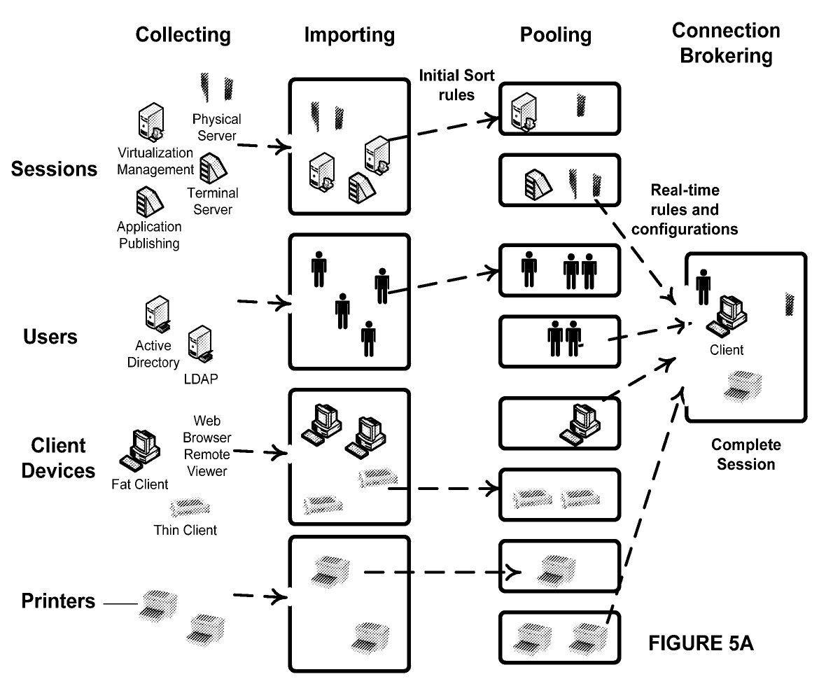

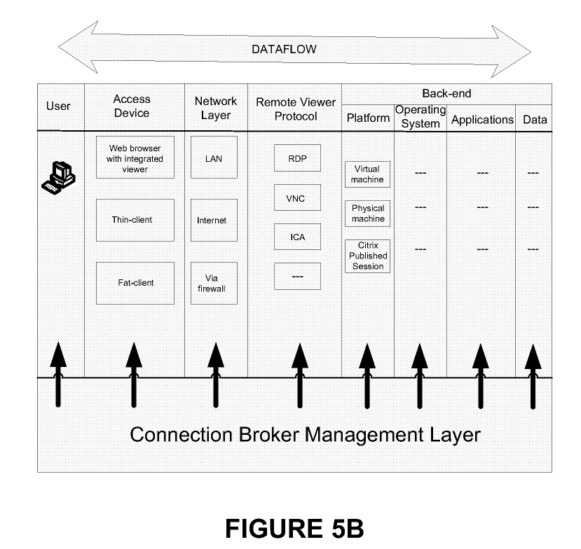

Pooling in accordance with the present invention will now be discussed with regard to FIG. 5 in terms of VM pooling. Here, a user 50 is shown to be provided by the CB 100 to a VM 52a that is assigned a certain predetermined access policy stored within the access control rules 8. Each access policy can set the session variables (such as screen size), independently for each class of client (Web, Fat, and Thin). Furthermore, variables such as printer assignment can be determined by client location. Stated otherwise, the user 50 has a certain Active Directory™ group membership characteristic that the CB 100 applies against the access policy stored in the access control rules 8 such that VM 52a is assigned from a certain pool 52 of VMs that have been associated with that specific access policy. It should of course be noted that any of the hosted desktops (here VMs) that are not functional, or otherwise in use by rogue users, are not assignable to the user 50. Accordingly, hosted desktops can be remotely managed and assigned to users from a pool and advantageously returned to the pool after use.

It should be understood that pooling is only a part of the underlying mechanisms of the present inventive method and apparatus. FIG. 5A shows pooling in context among the overall operational scheme of the present invention. Here, the operation of the present invention is categorized into four distinct stages: (1) collecting; (2) importing; (3) pooling; and (4) connection brokering. Within the collecting stage, various elements within the network in the form of the different types of sessions, users, client devices, and printers are first identified by the CB. Examples of sessions may include virtualization management, application publishing, terminal server, or a physical server. The users may be in the form of Active Directory™, LDAP, or the like. Examples of client devices may be any known fat-client application, thin-client application, or web browser remote viewer application. Printers may be in the form of a physical printing station or any suitable comparable device such as, but not limited to, a facsimile (fax) device, virtual fax, or print-to-email mechanism.

After the sessions/users/devices/printers are collected, the members of each a then imported into the CB. Rules are then applied so as to sort the members into pools. An example of this would be that certain all users are identified and some sorted into an accounting pool while others are sorted into an engineering pool. Pooling may be subject however to manual over-ride whereby an accounting user, for example, may be sorted into a human resource pool instead of or additional to the accounting pool. After pooling, connection brokering occurs in a real-time manner so as to effect a certain configuration for that user. Progress reporting keeps a user informed of brokering progress and errors associated with assigning a desktop, such as “no Hosted Desktop available” or “Hosted Desktop starting.” In this manner, the present invention advantageously produces final connection brokering that is accomplished in real-time taking into account such issues as, but not limited to, the location of the user, the device they are using, the load on the back end systems, and the user's normal home location. This dynamically completes a session by selecting the appropriate components for the given user and establishes the session for that specific user configuration. For example, the accounting user would be set up remotely to a hosted desktop in the form of a VM including all the engineering software applications normally allocated to that user's work desktop as well as their appropriate workplace printer.

FIG. 5B illustrates the management layer characteristics in the context of the overall operational scheme of the present invention. The various parts of any remote access scheme include a user, the access device, the network layer, the remote viewer protocol, and the back-end elements that are desired to be accessed remotely. Such back-end elements include the given platform (e.g., virtual machine), operating system (e.g., Windows XP™), various user applications (e.g., MS-Word™), and related stored user data. FIG. 5B shows these various parts as they are typically layered within a remote access scheme. It can be seen that the method and apparatus in accordance with the present invention is shown as the management layer which is in communication with each part of the network. More importantly, the management layer in accordance with the present invention does not reside within any given data path, but rather communicates with the various points in the network by way of a novel connection brokering mechanism discussed further hereinbelow.

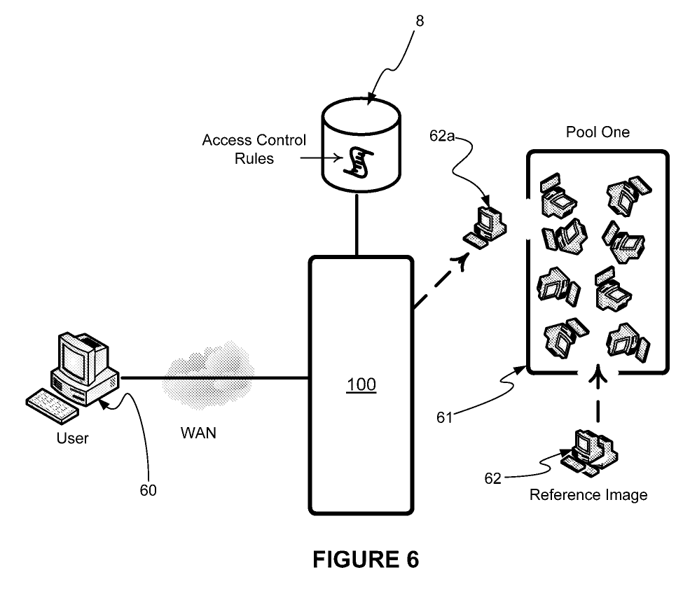

Continuing with the example of an engineering user, a given enterprise may find it appropriate to provide each engineering user with a certain desktop configuration that is unique to that particular pool of users. For instance, the electrical engineering staff may comprise one pool that utilizes circuit diagramming software applications whereas the mechanical engineering staff may comprise another pool that utilizes computer aided drafting software applications. In such instance, there may be provided in accordance with the present invention a template VM unique to electrical engineering staff that differs from another template unique to mechanical engineering staff whereby the templates differ in the software applications related to mechanical and electrical engineers. FIG. 6 illustrates this approach whereby a reference image 62 (e.g., template or physical machine) may exist that may be cloned by the CB 100 in accordance with pool control rules 8a in order to create an appropriate cloned VM 62a as a remote desktop for the user 60 from a VM pool 61. It should be understood that such template 62 may be dynamically modified to fit the deployment—e.g., the amount of memory or disk space can be changed according to the user profile. The use of templates enables the present invention to creating the backend resources (as shown in FIG. 5B) by either dynamically provisioning the hosted desktop 62a by using the template 62. Alternatively, this may be accomplished by cloning a base image of the given desktop from the pool or converting such desktop from a “fat” desktop. Such dynamic provisioning may be done either on a one-off or a repeated basis.

The present invention also provides a level of “stickiness” in terms of retaining session connections during breaks in the network. The assignment of a particular hosted desktop to a user may be permanent, or just for a preset period of time. Because the present invention manages the endpoint of the network and not the network itself, users are associated with a particular entry in the CB database irrespective of which device is used to connect. The time duration of this association is retained by the CB is dependent upon certain variables that may include, without limitation, whether the break is a log-out versus disconnections and how much time has passed since the last log-on. For instance, the occurrence of an intermittent disconnect would not force a user to re-build a session, whereas a time since last log-on of 24-hours would likely remove any stored association of a user with a given hosted desktop. In this manner, remote server resources can be judiciously utilized without impacting a remote user's experience when working over poor network connections. This ensures that users keep their desktop configuration even when there is a network interruption, though hosted desktops are not tied up unnecessarily. The hosted desktop communications API (or hosted desktop agent within the hosted desktop) would be used to differentiate between log-offs and disconnects.

Similarly, a user's hosted desktop (e.g., VM) policy may determine the state of the VM at log-on of that user. The CB would place the user's VM into the policy-determined state to thereby start the VM on log-on and stop the VM on log-out, or suspend the VM on log-out and resume the VM on assignment. This would be more akin to an idle state for some a VM allotted for certain user's (e.g., VIP users versus rank-and-file users). However, this dynamic management of the hosted desktop state allows each VM state to be automatically changed when assigned and un-assigned, thereby allowing unused VMs to be kept in a powered-off state which economizes both licensing and hardware utilization.

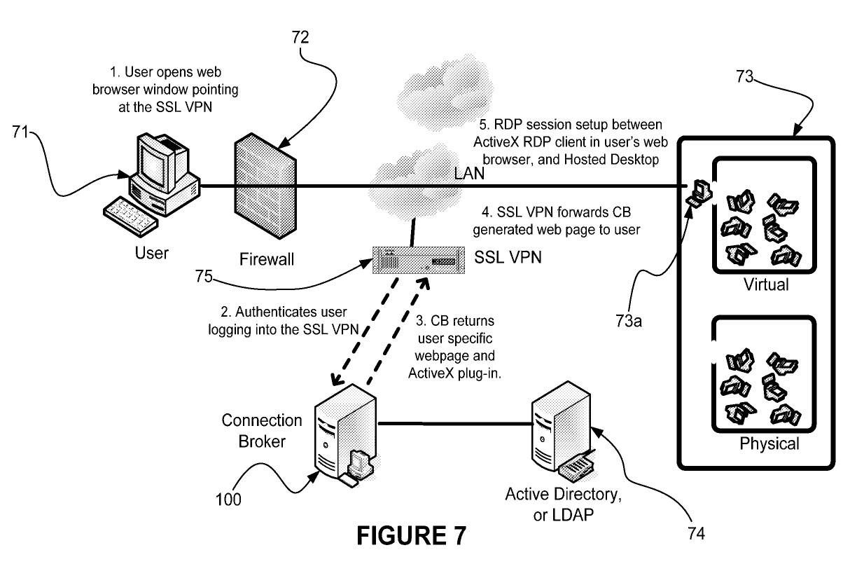

As already mentioned, the CB in accordance with the present invention dynamically assigns users to hosted desktops running on physical or virtual machines. While users may have single sign-on access their assigned desktops using the inventive CB for fat-clients (e.g., Windows 2000™, XP™, and Vista™), thin-clients (e.g., from Devon IT, Neoware, and Wyse), or simply using a web browser, there is also a readily apparent need for some level of support for encrypted networking. Thus, integration with third party secure hardware (e.g., secure socket layer (SSL) VPN hardware) is necessary to ensure the same single log-on experience from outside a firewall. Accordingly, authentication and RDP sessions can be secured using SSL certificates to ensure data security. FIG. 7 illustrates one example of the present invention in operation with SSL-VPN hardware.

With regard to FIG. 7, one embodiment of the present invention is shown as used for SSL VPN remote access of a hosted desktop 73a by a user 71. In such web-based, the 71 is typically located behind a firewall 72. Operation for such SSL-VPN access would typically require that the user 71 initially open their web browser pointing at the SSL-VPN so as to log-on to the webpage of the SSL-VPN hardware 75. In certain alternative implementations of the present invention (e.g., for carrier-class solutions within large enterprises), authentication may typically involve a third-party authentication server typically used as a management component to verify authentication requests and to administer policies for enterprise networks. Although not shown, an RSA ACE/Server™ (from RSA Security Inc. of Bedford, Mass.) could be used as one such typical management component whereby the SSL-VPN 75 would perform a 2-factor authentication (authentication token and username) against the RSA ACE/Server™, before performing 2-factor authorization (username and password) against the CB 100 in order to pass to the CB 100 the necessary variables for single sign-on to the hosted desktop 73a. Again, any such third party authentication server should be understood as optional.

In conjunction with any third party authentication server (if used) or exclusively (if no such third party authentication server is used), the SSL-VPN 75 passes the username and password across an encrypted channel such that further authentication is performed via the CB 100 against an Active Directory™ or LDAP 74 by performing 2-factor authorization (username and password) against the CB 100 in order to pass to the CB 100 the necessary variables for single sign-on to the hosted desktop 73a. As in a non-VPN scenario described earlier, the CB 100 will determine the appropriate hosted desktop 73a. In this scenario however, the CB 100 will pass RDP session variables plus an IP address for a user-specific webpage and ActiveX™ plug-in. The SSL-VPN 75 then forwards the web page generated by the CB 100 to the user 71. Thereafter, the RDP session is setup between the ActiveX™ RDP client in the user's web browser and the hosted desktop 73a.

In addition to highly secure network implementations as mentioned above, some network operators may require a much higher level of robustness. The present invention provides such robustness whereby the CB checks the state of hosted desktops before assigning or re-assigning them. If a hosted desktop fails, then it is automatically replaced by another from the same pool. Accordingly, the failure of a host server would only cause limited disruption—i.e., the user would simply re-authenticate and be assigned a new hosted desktop. FIGS. 8, 8A, 8B, 8C, and 8D illustrate both failover and clustering scenarios in accordance with the present invention.

In FIG. 8, a user 81 is shown as assigned to a hosted desktop 83a chosen from a pool of Citrix sessions 83. Within the available remote resources 82, may of course also be physical 84 or virtual machines 85. Here, the user 81 and remote resources 82 are operatively coupled to a brokering cluster with a first CB 101 and a second CB 102 arranged in parallel. The brokering cluster can therefore manage multiple VM, Citrix sessions, as well as physical machines directly hosting desktops. Although only two CBs 101 and 102 are shown, many more may be arranged in parallel. For example, by clustering CBs connected to a common external database 8a and using a load balancer 86 to spread the load, it is possible to manage up to a million hosted desktops by using a cluster of up to 64 CBs. In this manner, a failure of any one CB (e.g., 101 or 102) will simply result in the user session being re-assigned to another CB (e.g., the other of 101 or 102) without any interruption in service. To further improve robustness, there may further exist a second external database 8b mirrored to database 8a with corresponding CBs 103 and 104. Upon failure of the primary CBs and database (101, 102, 8a), the secondary CBs and database (103, 104, 8b), would take over management of the remote session.

In FIG. 8A, a portion of the present invention is illustrated where the CB 100 is operatively coupled to the host server 82a on which a virtual server 202 exists having at least one remote desktop 203 (i.e., VM). The host server 82a of course typically includes at least a network interface 206, disk storage 207, and a central processing unit (CPU) 208. In addition to virtual hardware 205 of the remote desktop 203, there is also included on the remote desktop 203 a hosted desktop communications API 204 by which the CB 100 manages the hosted desktop connection. The hosted desktop API 204 may be in the form a hosted desktop agent in the hosted desktop, or a relay that connects external APIs into the operating system running within the hosted desktop to the CB. The API 204 (or agent in the hosted desktop) feeds back to the CB 100 the status of a particular hosted desktop. Such status information includes; addresses and the status (e.g., online, disconnected) of users logged in. It can also be used to shut down the remote viewer service in order to prevent unauthorized access, and log off unauthorized (i.e., rogue) users.

In operation, the CB 100 may provide a heartbeat function such that monitoring of the remote desktop 203 would occur via pinging the remote desktop 203 as well as the host server 82a to ensure proper and continuous operation of the host server 82a and related remote desktop 203. In the event of connection problems identified through the pinging process (or alternatively through manual intervention during disaster recovery), the CB 100 would initiate a failover process to cause a second VM (shown by dotted lines in host server 82b) to be set up as illustrated in FIG. 8B. The access control rules 8 coupled to the CB 100 would include a configuration file that includes only the session variables corresponding to the given user and saved as a VM config file. In the instance of a network connection error being identified, the CB 100 would cause the VM config file to be copied to a second host server 82b such that a remote desktop identical to the first is created on the second host server 82b. The configuration files may be inputted (by an IT manager) or may be created in a more automated, dynamic manner using a scripting language.

The first (i.e., primary) external database 8a and the second (i.e., backup) external database 8b may form a storage area network (SAN) configuration. While not described herein, such SAN configurations are well known in the art to consist of storage elements, storage devices, computer systems, and/or appliances, plus all control software, communicating over an Ethernet-based network. As such, each external database 8a and abase 8b may contain the images of the hosted desktops as well as any configuration file associated with those hosted desktops. The CBs 102-104 in the primary and secondary datacenters 8a and 8b would typically use database replication to accomplish this, though the SAN mirroring process could be used. Accordingly, failure of one datacenter (detected via ping or manual intervention) would result in the remote user would be remapped to alternate hosted desktops. If necessary, rewriting of the config files and changing the network configuration within the hosted desktops to match the new environment may also occur without straying from the intended scope of the present invention.

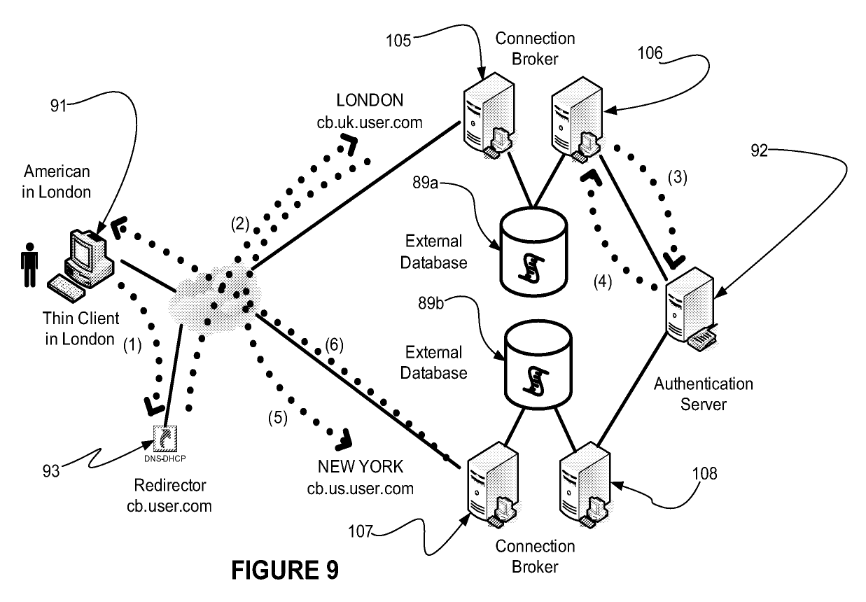

As mentioned, hosted desktop images can be mirrored from the primary datacenter to the backup datacenter. Each database and corresponding CBs are located together at different corresponding primary and backup locations. Such SAN mirroring or data replication would therefore provide a further level of safety in network recovery and resiliency in the face of catastrophic events affecting network elements. That is to say, failure at the primary datacenter would result in the users being transferred to the backup datacenter (using global load balancing (not shown), or the global location redirection as discussed hereinbelow with regard to FIG. 9) to transparently switch users from VM (shown by solid lines within server 82a) at one location to another VM (shown by dotted lines within server 82b).

While clustering is useful within the context of network recovery and resiliency, the present invention may also utilize such in the broader context efficient management of global networks. Global networks, within for example large corporate enterprises, however utilize a slightly different approach to the connection brokering thus far described hereinabove. Such global network management in regard to the present invention would therefore include location based connection brokering as shown in FIG. 9.

With regard to FIG. 9, the present invention is illustrated, by way of example, in terms of a thin-client user 91 based in the New York City (NYC) office of the user's large corporate employer, but temporarily located in London. Clusters of London-based CBs 105, 106 are shown having a corresponding external database 89a containing the access control rules for London based employees. As well, clusters of NYC-based CBs 107, 108 are shown having a corresponding external database 89b containing the access control rules for NYC-based employees. While termed “London-based”, it should be readily apparent that the CBs 105, 106 and external database 89a may in fact be located only geographically near to London (e.g., the CBs could be in Belgium and the external database in Spain). Likewise, the “NYC-based” CBs could conceivably be physically located in Arizona and the external database in Nova Scotia). An authentication server 92 and global redirector 93 are also provided and may be located at any place in regard to the global network. While two CBs are shown in each cluster, it should be readily apparent that any number of CBs in parallel may be used as discussed hereinabove.

With further regard to FIG. 9, operation of location based connection brokering in accordance with the present invention would first involve the NYC-based user 91 located in London to connect to a global CB in the form of the redirector 93 (e.g., cb.user.com). The user 91 would then be redirected to one of the local CBs 105, 106 (e.g., cb.uk.user.com). The local London-based CB 105 or 106 to which the user 91 has been directed would thereafter authenticate the user 91 against the authentication server 92. The authentication server 92 would be configured such that the authentication server 92 would inform the local CB which home CB in the network corresponds to the user 91. In the scenario shown, the authentication server 92 informs the local CB 105 or 106 that the user 91 belongs to a NYC-based CB shown as clustered CBs 107 and 108. The local London-based CB 105 or 106 then uses this information to redirect the user 91 to their home CB 107 or 108, by either acting as a transparent proxy, or by sending a re-direct command to the client device 91, along with the address of the home CB 107.

Thereafter, the session setup occurs normally as described before such that the home CB 107 or 108 returns the user's session setup data from the NYC-based database 89b to the thin-client remote desktop software of the user 91. By always using a global CB in the form of the redirector 93, a user would advantageously avoid having to change their settings on their remote user device.

Other useful additional aspects and features of the user interface may be included within the present method and apparatus without straying from the intended scope of invention. Specifically, the present invention may include monitoring and reporting features such that the user is provided with real-time monitoring of RDC sessions, and reporting via email or simple network management protocol (SNMP). In this way, the present invention provides a more reliable monitoring solution because it takes into account the state of the hosted desktop. The present invention may further include external authentication such that users can be authenticated and profiled using Active Directory™ or LDAP servers without a schema change, so the introduction of hosted desktops does not depend on changes to the existing authentication system. The present invention may further provide user activity monitoring and logging such that the user status is displayed, user activity is logged, and users can be logged out of the system so as to provide IT managers with a central view of all user activity.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of managing remote computer resources comprising:
collecting elements of varied type within a network;
importing members corresponding to each said varied type into a processing unit for brokering connections within said network;
sorting said members into member pools in accordance with predetermined rules; and
forming in real-time, by way of said processing unit, a remote networking session for a remote user corresponding to one of said members in accordance with a configuration unique to said remote user.

2. The method as claimed in claim 1 further including inputting said configuration unique to said remote user.

3. The method as claimed in claim 1 wherein said forming step is accomplished with regard to network variables selected from a group consisting of: a location of said remote user, a device used by said user, load on back-end systems within said network, and a normal home location of said user.

4. The method as claimed in claim 2 wherein said configuration is input via said processing unit.

5. The method as claimed in claim 1 wherein said predetermined rules within said sorting step are capable of being modified via said processing unit.

6. The method as claimed in claim 1 wherein said elements include sessions, users, client devices, and printers.

7. The method as claimed in claim 1 wherein said predetermined rules and said configuration are stored remote from said processing unit.

8. The method as claimed in claim 1 wherein
a copy of said configuration is stored in a first external database remote from said processing unit and
a mirror copy of said configuration is stored in a second external database remote from said processing unit.

9. An apparatus for managing remote computer resources comprising:
a processing unit for brokering connections within a network, said processing unit capable of: collecting elements of varied type within said network, importing members corresponding to each said varied type into said processing unit, sorting said members into member pools in accordance with predetermined rules, and forming, in real-time, a remote networking session for a remote user corresponding to one of said members in accordance with a configuration unique to said remote user; and
a storage unit capable of retaining said predetermined rules and said configuration, said storage unit operatively coupled to said processing unit.

10. The apparatus as claimed in claim 9 wherein said processing unit forms said remote networking session with regard to network variables selected from a group consisting of: a location of said remote user, a device used by said user, load on back-end systems within said network, and a normal home location of said user.

11. The apparatus as claimed in claim 9 wherein said elements include sessions, users, client devices, and printers.

12. The apparatus as claimed in claim 9 wherein said storage unit is remote from said processing unit.

13. The apparatus as claimed in claim 9 wherein
a copy of said configuration is stored in a first external database remote from said processing unit,
a mirror copy of said configuration is stored in a second external database remote from said processing unit, and
said first external database being located apart from said second external database.

14. The apparatus as claimed in claim 13 wherein
said first external database is connected to a first cluster of processing units for brokering connections within said network and
said second external database is connected to a second cluster of processing units for brokering connections within said network.

15. The apparatus as claimed in claim 12 further including more than one said processing unit, each said more than one said processing unit operatively coupled to said storage unit and selectable by way of a load balancer.

16. A method of managing remote computer resources comprising:
collecting elements of varied type within a first geographical area of a geographically diverse network;
importing members corresponding to each said varied type into a processing unit for brokering connections within said first geographical area;
sorting said members into member pools in accordance with predetermined rules;
repeating said steps of collecting, importing, and sorting for a second geographical area of said geographically diverse network;
redirecting, by way of a redirector unit, a remote user to one said processing unit corresponding to one of said first or second geographical area of said geographically diverse network corresponding to a home location of said remote user; and
forming in real-time by way of said processing unit to which said redirector unit has redirected said remote user, a remote networking session for said remote user corresponding to one of said members in accordance with a configuration unique to said remote user.

17. The method as claimed in claim 16 further including inputting said configuration unique to said remote user.

18. The method as claimed in claim 16 wherein said forming step is accomplished with regard to network variables selected from a group consisting of: a location of said remote user, a device used by said user, load on back-end systems within said network, and a normal home location of said user.

19. The method as claimed in claim 16 wherein said configuration is input via each said processing unit.

20. The method as claimed in claim 16 wherein said predetermined rules within said sorting step are capable of being modified via each said processing unit.

21. The method as claimed in claim 16 wherein said elements include sessions, users, client devices, and printers.

22. The method as claimed in claim 16 wherein said predetermined rules and said configuration are stored remote from each said processing unit.

23. The method as claimed in claim 16 wherein a copy a copy of said configuration is stored in a first external database remote from said processing unit and
a mirror copy of said configuration is stored in a second external database remote from said processing unit.

24. The method as claimed in claim 1 wherein said processing unit communicates with a device of said remote user via an application programming interface that provides real-time connection progress information to said remote user.

25. The apparatus as claimed in claim 9 wherein said processing unit communicates with a device of said remote user via an application programming interface that provides real-time connection progress information to said remote user.

26. The method as claimed in claim 16 wherein said processing unit communicates with a device of said remote user via an application programming interface that provides real-time connection progress information to said remote user.

27. The method as claimed in claim 1 wherein said remote networking session is formed by dynamically provisioning a hosted desktop by way of a copying mechanism.

28. The method as claimed in claim 27 wherein said copying mechanism is selected from a group consisting of a cloning a base image, utilizing a template, and conversion from a fat desktop.

29. The method as claimed in claim 28 wherein said hosted desktop is dynamically provisioned in a one off manner.

30. The method as claimed in claim 28 wherein said hosted desktop is dynamically provisioned on a repeated basis.

31. The apparatus as claimed in claim 9 wherein said remote networking session is formed by dynamically provisioning a hosted desktop by way of a copying mechanism.

32. The apparatus as claimed in claim 31 wherein said copying mechanism is selected from a group consisting of a cloning a base image, utilizing a template, and conversion from a fat desktop.

33. The apparatus as claimed in claim 32 wherein said hosted desktop is dynamically provisioned in a one off manner.

34. The apparatus as claimed in claim 32 wherein said hosted desktop is dynamically provisioned on a repeated basis.

35. The method as claimed in claim 16 wherein said remote networking session is formed by dynamically provisioning a hosted desktop by way of a copying mechanism.

36. The method as claimed in claim 35 wherein said copying mechanism is selected from a group consisting of a cloning a base image, utilizing a template, and conversion from a fat desktop.

37. The method as claimed in claim 36 wherein said hosted desktop is dynamically provisioned in a one off manner.

38. The method as claimed in claim 36 wherein said hosted desktop is dynamically provisioned on a repeated basis.

39. The method as claimed in claim 1 wherein said configuration is created dynamically via a scripting language.

40. The apparatus as claimed in claim 9 wherein said configuration is created dynamically via a scripting language.

41. The method as claimed in claim 16 wherein said configuration is created dynamically via a scripting language.
